(19) United States
(12) Patent Application Publication
(10) Pub. No.: US 2009/0063211 A1
(43) Pub. Date: Mar. 5, 2009

(54) Finding a Shortest Waste Credit Path for a Manufacturing Process

(76) Inventors: Camilo Yamauchi Campo, Sao Paulo (BR); Lucas Goncalves Franco, Campinas (BR); Breno Henrique Leitao, Campinas (BR); Wainer dos Santos Moschetta, Campinas (BR)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/847,420

(22) Filed: Aug. 30, 2007

(51) Int. Cl. G06F 17/00

(52) U.S. Cl. 705/7

(57) ABSTRACT

In an embodiment, a directed graph is created that includes nodes and directed edges that connect the nodes. The nodes represent components and processes, and the directed edges represent a time order of the components and processes in manufacturing processes. Amounts of waste credits for tail nodes in the directed graph are calculated and stored as weights of entering directed edges of the respective tail nodes. The waste credits represent tradable permits for the components and processes to emit waste as part of the manufacturing processes. A shortest path from a begin node to a final node is found, where the shortest path has a lowest sum of its weights, as compared to the sum of the weights for all other paths that exist in the directed graph from the begin node to the final node.

### FIELD

An embodiment of the invention generally relates to finding the shortest path in a manufacturing process that consumes the least amount of waste credits.

### BACKGROUND

An important problem in the modern world is the handling, treatment, and prevention of greenhouse gas emissions, such as carbon dioxide, which occur as the byproduct of many manufacturing processes. One technique that attempts to reduce greenhouse gas emissions is known as the Kyoto Protocol, under which participating countries set quotas on the amount of greenhouse gases that those countries can emit. The governments of the countries, in turn, set quotas on the emissions of businesses that operate with the countries, e.g., in the form of carbon credits.

One carbon credit gives its owner the right to emit one unit (e.g., one tonne or metric ton) of carbon dioxide. Businesses that emit carbon dioxide in an amount that exceeds their allotted carbon credits must buy additional carbon credits for their excess emissions, while businesses that are below their quotas can sell their remaining credits. By allowing carbon credits to be bought and sold on an open market, a business for which reducing its emissions would be expensive or prohibitive can pay another business to make the reduction. This reduces the quota's impact on the business, while still reaching the quota. Thus, carbon credits are a tradable permit scheme that assigns carbon dioxide gas emissions a monetary value.

Businesses naturally prefer to minimize their costs by minimizing the emissions that result from their manufacturing processes, but determining how to do so is a difficult problem because products often include many component parts and are manufactured via many processes or sub-processes at different locations, each of which can consume (use up by emitting carbon) different amounts of carbon credits. Further, the selection of one alternative component or process with a lowest carbon dioxide emission might actually raise the total emission. Consider the example of a business that manufactures components at various manufacturing locations and then ships them to various assembly locations. If the manufacturing location that consumes the lowest carbon credits is the farthest away from the lowest carbon credit assembly location, whatever savings are obtained by using the lowest carbon credit locations might be offset by the high carbon emission cost of shipping the components. Further, if the lowest carbon credit assembly location is the farthest from the customer location, whatever savings are obtained by using the lowest carbon credit assembly location might be offset by the high carbon credit cost of shipping the final product.

Thus, businesses need a better way to reduce their consumption of carbon credits. Although the aforementioned problems have been described in the context of carbon credits and carbon dioxide, they could also apply to other waste byproducts, such as waste paper, scrap metals, methane, nitrous oxide, hydro fluorocarbons (HFCs), or any other waste items. Further, although the aforementioned problems have been described in the context of the Kyoto Protocol, they apply equally to any initiative that uses waste credits, such as the European Union Emissions Trading Scheme and the United Nations Clean Development Mechanism.

### SUMMARY

A method, apparatus, system, and storage medium are provided. In an embodiment, a directed graph is created that includes nodes and directed edges that connect the nodes. The nodes represent components and processes, and the directed edges represent a time order of the components and processes in manufacturing processes. Amounts of waste credits for tail nodes in the directed graph are calculated and stored as weights of entering directed edges of the respective tail nodes. The waste credits represent tradable permits for the components and processes to emit waste as part of the manufacturing processes. A shortest path from a begin node to a final node is found, where the shortest path has a lowest sum of its weights, as compared to the sum of the weights for all other paths that exist in the directed graph from the begin node to the final node. In this way, in an embodiment, a manufacturing process is chosen that emits minimum waste and uses a minimum amount of waste credits, which reduces cost.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of an example user interface, according to an embodiment of the invention.

FIG. 3 depicts a block diagram of an example product graph, according to an embodiment of the invention.

FIG. 4 depicts a block diagram of example shortest path, according to an embodiment of the invention.

FIG. 5 depicts a flowchart of example processing for finding a shortest path in a product graph, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

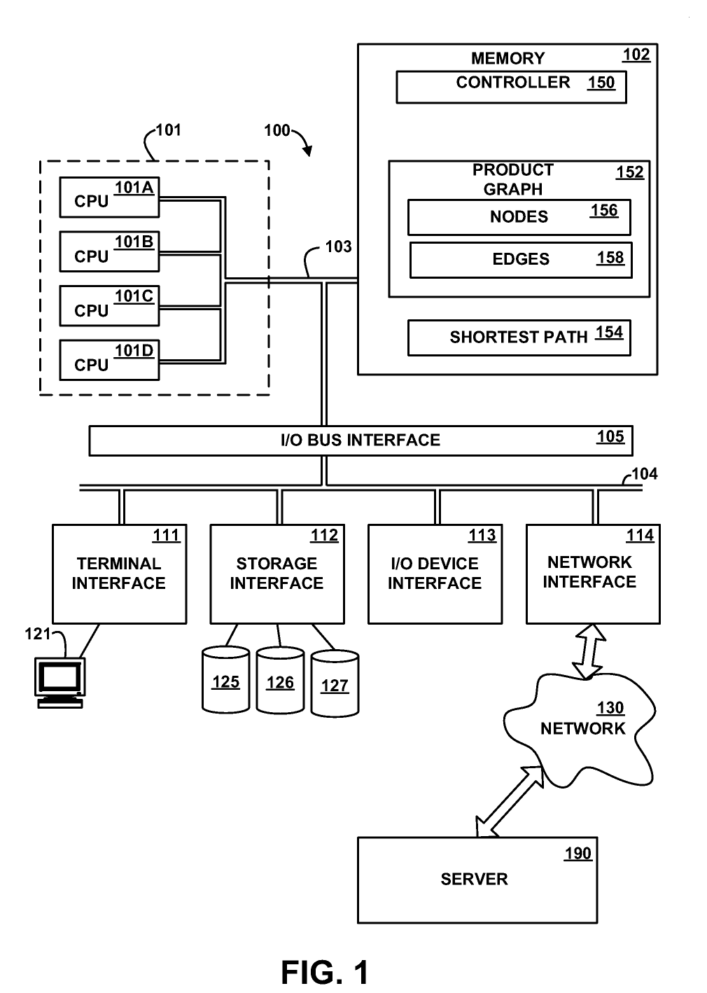

Referring to the Drawings, wherein like numbers denote like parts throughout the several views, FIG. 1 depicts a high-level block diagram representation of a client computer system 100 connected to a server computer system 190 via a network 130, according to an embodiment of the present invention. The terms “client” and “server” are used herein for convenience only, and in various embodiments a computer system that operates as a client in one environment may operate as a server in another environment, and vice versa. In an embodiment, the hardware components of the computer system 100 may be implemented by a IBM System i5 computer system, respectively, available from International Business Machines Corporation of Armonk, N.Y. But, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing or encoding data and programs. In another embodiment, the main memory 102 represents the entire virtual memory of the computer system 100, and may also include the virtual memory of other computer systems coupled to the computer system 100 or connected via the network 130, such as the server computer system 190. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes a controller 150, a product graph 152, and a shortest path 154. Although the controller 150, the product graph 152, and the shortest path 154 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the controller 150, the product graph 152, and the shortest path 154 are illustrated as being contained within the main memory 102, these elements are not necessarily all completely contained in the same storage device at the same time. Further, although the controller 150, the product graph 152, and the shortest path 154 are illustrated as being separate entities, in other embodiments some of them, portions of some of them, or all of them may be packaged together.

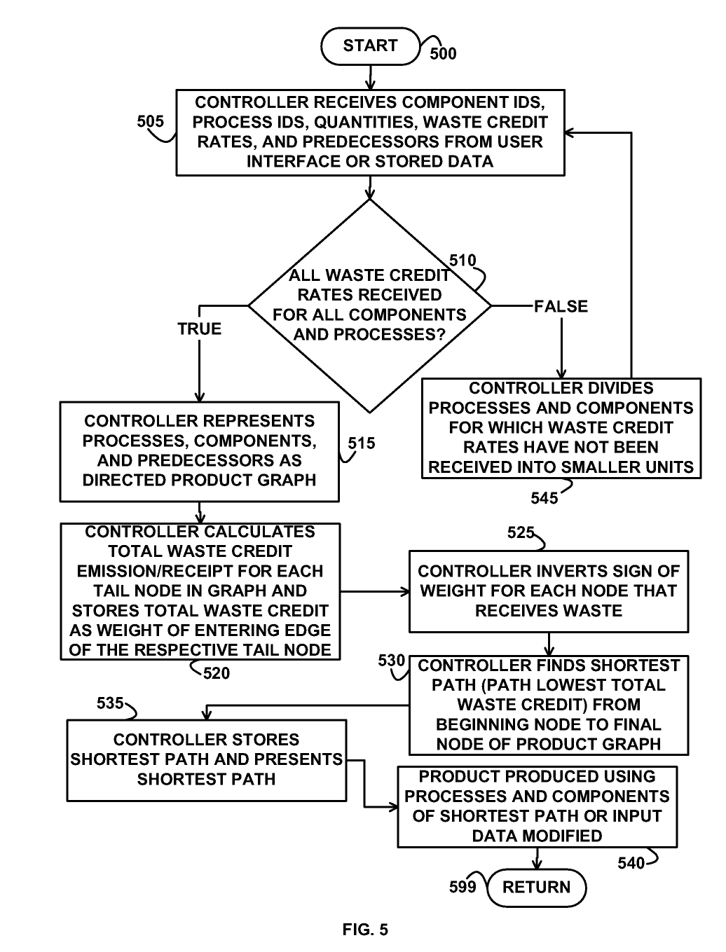

In various embodiments, the controller 150 may be implemented via an operating system, a user application, a third-party application, or any combination thereof. In various embodiments, the controller 150 includes instructions capable of executing on the processor 101 or statements capable of being interpreted by instructions that execute on the processor 101 to perform the functions as further described below with reference to FIG. 5. In another embodiment, the controller 150 may be implemented in hardware via logic cards, circuit cards, logic gates, and/or other hardware elements. Since, as explained above, the controller 150 may include a combination of components, one component may perform one action while another component performs another action.

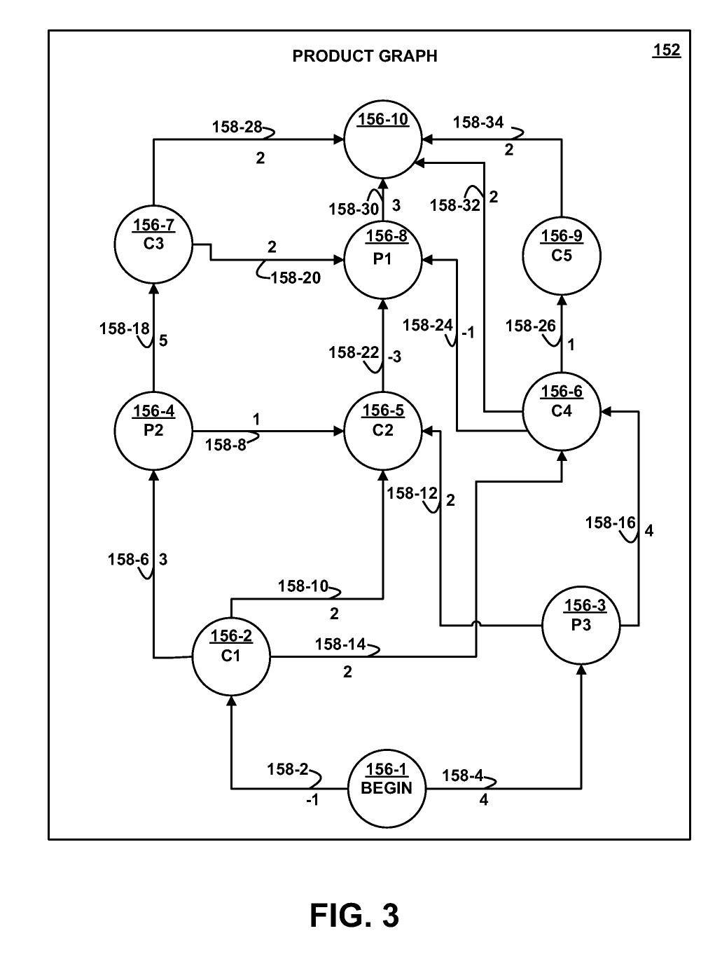

The product graph 152 includes a set of nodes 156, also called vertices, and a set of directed edges 158. An example of the product graph 152 is further described below with reference to FIG. 3. The product graph 152 is a data structure that represents multiple, alternative manufacturing processes, operations, or procedures, whose end result is a product. The manufacturing processes may include one or more processes, sub-processes, operations, steps, procedures, or actions and may act on one or more components, all of which are represented by the nodes 156.

For example, a business that builds houses acquires nails and lumber, which are examples of components and performs a process of nailing or connecting pieces of lumber together using the nails. Thus, in this example, the nodes 156 represent the components of the nails and the lumber and also represent the process of nailing lumber together using the nails.

The directed edges 158 represent the relationships between the nodes 156. Each of the directed edges 158 has an associated direction, so the product graph 152 is said to be a directed graph. The directions of the directed edges 158 represent the flow of the manufacturing process in time order, such as a predecessor or prerequisite relationship of the nodes. For example, the lumber and the nails must be acquired before the pieces of lumber can be nailed together, so the components of the lumber and the nails are prerequisites or predecessors to the nailing process, in time. Thus, the direction of the directed edge between the lumber node (representing acquisition of the lumber) and the nailing process node flows from the lumber node to the nailing process node, and the direction of the directed edge between the nail node (representing acquisition of the nails) and the nailing process node flows from the nail node to the nailing process node.

Each of the directed edges 158 further has an associated weight. The weights represent amounts of waste credits associated with the nodes 156, that is, the amount of waste that is emitted or received by the execution, carrying out, or action of the processes and by the acquiring of the components. In an embodiment, a waste credit is implemented as a carbon credit, but in other embodiments any type of waste and unit of waste may be used, such as waste paper, scrap metals, methane, nitrous oxide, hydro fluorocarbons (HFCs), or any other type of waste items. Waste is a material, element, or item, regardless of form, that is harmful, undesirable, or unwanted.

The weights can be either positive, indicating emission of an amount of waste, or negative, indicating receipt of an amount of waste. Emission of a waste occurs when the acquisition of the component or the performance of the process represented by the corresponding node causes waste to be emitted into the environment. In various embodiments, the environment may be the atmosphere, a landfill, a lake, a river, a sea, an ocean, ground water, soil, or any physical location outside the property owned, rented, or used by the business. Receipt of a waste occurs when the acquisition of the component or the performance of the process represented by the corresponding node causes waste to be accepted from the environment and reused or recycled. A process or component may both emit and receive waste, so the weight represents the net or cumulative amount of waste emitted (or received).

For example, the nailing process may use an electric saw, the operation of which requires electrical power, which is generated by burning fuel, such as oil or gas. This power generation causes carbon dioxide to be emitted. Thus, the positive weight of the directed edge associated with the nailing process node reflects the emission of the carbon dioxide that the nailing process produces. As another example, the node that represents the acquisition of the lumber may accept waste paper from the environment and recycle the waste paper into an engineered wood product, such as fiberboard or particle board. Thus, the negative weight of the directed edge associated with the lumber node may reflect the receipt of waste paper that the acquisition receives and recycles. Another example of waste receipt may include the planting of trees, which as part of photosynthesis accept carbon dioxide and emit oxygen, thus reducing the amount of a waste in the environment, but the act of planting the trees may use machinery that burns fuel and emits carbon dioxide, so the weight associated with the process reflects the net waste receipt.

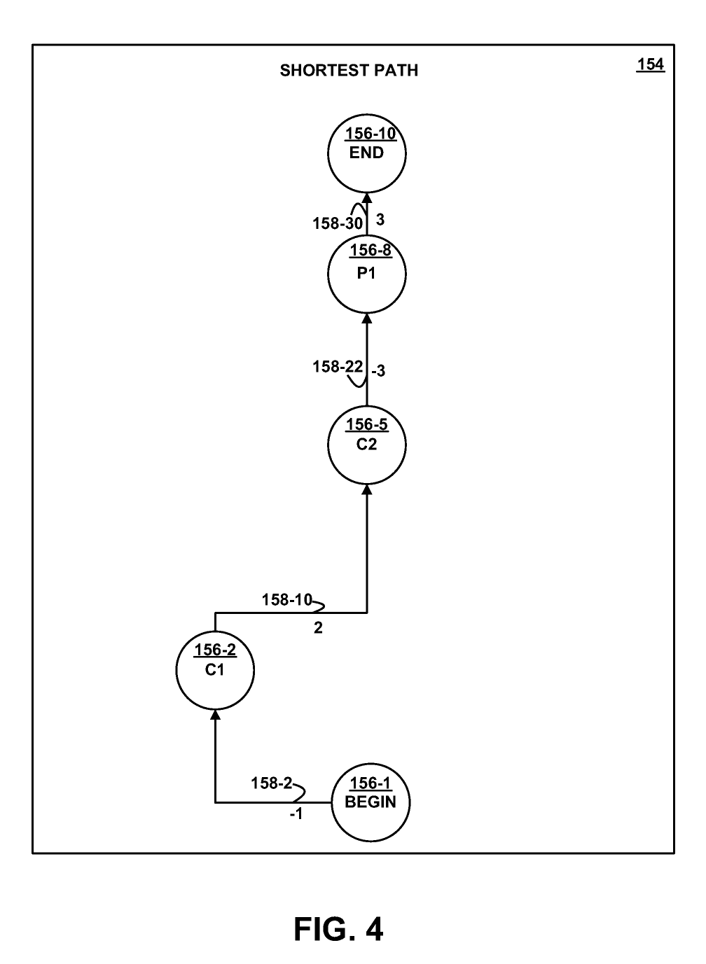

The shortest path 154 is a data structure that represents a path from a beginning to the end of one of the manufacturing processes represented by the product graph 152. The shortest path 154 is said to be the shortest in the sense that the sum of the weights associated with the directed edges of the shortest path 154 is smaller than the sums of the weights of all other paths from the beginning of their respective manufacturing process to the end of their respective manufacturing process. Thus, the product graph 152 may include multiple, alternative paths from the beginning of a manufacturing process to the end of a manufacturing process. For example, a first path may include a node that represents nails, a second path includes a node that represents screws, and a third path includes a node that represents glue, all of which are components that may be used for attaching pieces of lumber together. These different paths may have different sums of their respective weights, with one path being the shortest, meaning that it has the smallest sum of the weights associated with the directed edges that make up that path. An example of the shortest path 154 is further described below with reference to FIG. 4.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interface) bus, or any other appropriate bus technology.

The I/O interface units support communication with a variety of storage and I/O devices. For example, the terminal interface unit 111 supports the attachment of one or more user terminals 121, which may include user output devices (such as a video display device, speaker, and/or a Braille output device) and user input devices (such as a keyboard, mouse, touchpad, keypad, trackball, microphone, light pen, or other pointing device). The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types, such as printers or fax machines. The network interface 114 provides one or more communications paths from the computer system 100 to other digital devices and computer systems 190; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the computer system 100 may be a multi-user “mainframe” computer system, a single-user system, or a server or similar device that has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100 and the server computer systems 190. In various embodiments, the network 130 may represent a storage device or a combination of storage devices, either connected directly or indirectly to the computer system 100. In an embodiment, the network 130 may support the Infiniband architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The server computer system 190 may include some or all of the hardware components previously described above as being included in the client computer system 100.

It should be understood that FIG. 1 is intended to depict the representative major components of the client computer system 100, the network 130, and the server computer system 190 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., and are referred to hereinafter as “computer programs,” or simply “programs.” The computer programs typically comprise one or more instructions that are resident at various times in various memory and storage devices in the client computer system 100, and that, when read and executed by one or more processors in the client computer system 100, cause the client computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the client computer system 100 via a variety of tangible signal-bearing media that may be operatively or communicatively connected (directly or indirectly) to the processor or processors, such as the processor 101. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), the main memory 102, CD-RW, or diskette; or

(3) information conveyed to the client computer system 100 by a communications medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying computing services (e.g., computer-readable code, hardware, and web services) that implement, some or all of the methods described herein. Aspects of these embodiments may also include analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

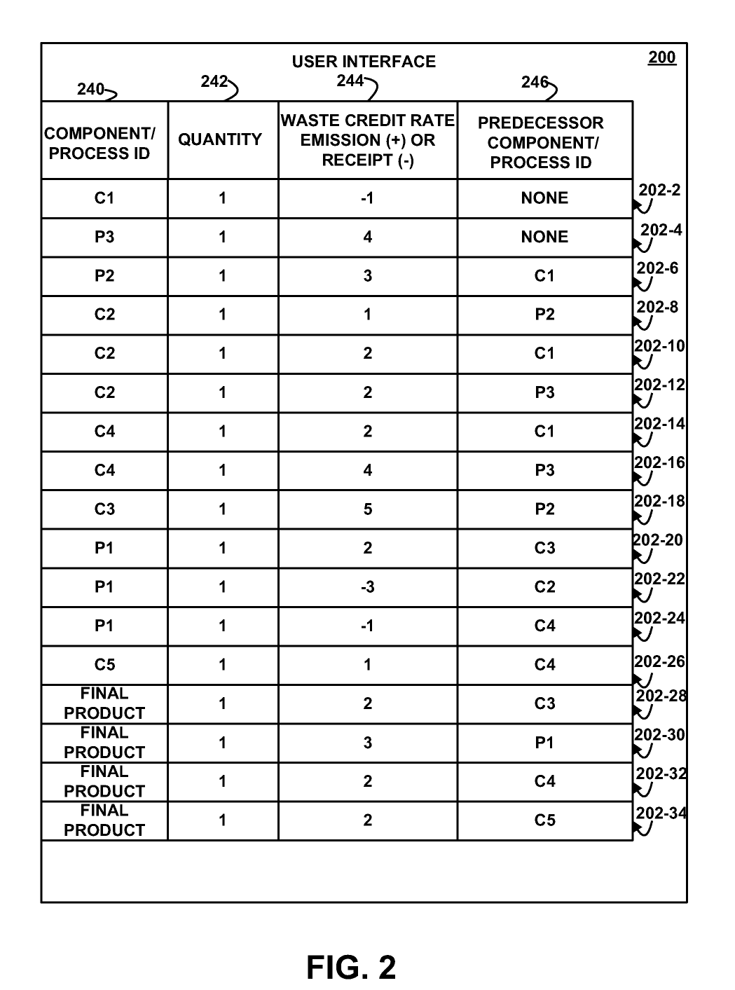

FIG. 2 depicts a block diagram of an example user interface 200, according to an embodiment of the invention. The controller 150 displays or presents the example user interface 200 via the user terminal 121. The example user interface 200 includes example data records 202-2, 202-4, 202-6, 202-8, 202-10, 202-12, 202-14, 202-16, 202-18, 202-20, 202-22, 202-24, 202-26, 202-28, 202-30, 202-32, and 202-34, each of which includes a component identifier or a process identifier field 240, a quantity field 242, a waste credit rate field 244, and a predecessor component or process identifier field 246. A user enters data into the records via the terminal 121 and sends the data records to the controller 150, which receives the data records. In another embodiment, the controller 150 reads the data contents of the records from a database, file, page, array, or other data repository.

The component/process identifier field 240 may identify a component that becomes a part of a product or that is used by a manufacturing process that creates a product. The component/process identifier field 240 may also identify a process or sub-process that performs steps or that acts on a component or components. Examples of components include nails, lumber, screws, bolts, metals, or any other piece of property, material, commodity, or item that can be used in manufacturing process that results in a product. A product is any entity that has a value, use, or purpose and that is composed of components. The quantity field 242 identifies an amount or number of the corresponding component or processes 240 in the same record.

The waste credit rate field 244 specifies an amount of a waste credit per unit of the corresponding component or process 240, in the same record. The waste credit rate 244 when multiplied by the quantity 242, in the same record, yields the weight or waste credit that is associated with, or is caused by, acquiring the component or executing the process identified by the component/process identifier 240. The waste credit rate 244 represents the amount of waste, per unit of a component or process 240, that is emitted or received by the execution, carrying out, or action of the process or by the acquiring of or use of the component. The waste credit rate 244 can be either positive, indicating emission of an amount of waste, or negative, indicating receipt of an amount of waste. In an embodiment, the user enters positive or negative numbers into the waste credit rate 244, but in other embodiments, the user enters an indication of whether waste is emitted or received, and the controller 150 modifies the sign of the waste credit rate 244, positive for emission and negative for receipt.

Waste credits represent tradable permits for the components and processes to emit waste. A waste credit is consumed or used by emitting waste. A waste credit is created by receiving or accepting and reusing or recycling waste and is created as an allotment to a business by a government. A waste credit is tradable, in the sense that it may be bought or sold on an open market. In an embodiment, a waste credit is implemented as a carbon credit, but in other embodiments any type of waste and unit of waste may be used, such as waste paper, scrap metals, methane, nitrous oxide, hydro fluorocarbons (HFCs), or any other type of waste items.

The predecessor component identifier or process identifier field 246 identifies the component or process that is the immediate predecessor or prerequisite to the component/process 240, in time order in a manufacturing process. Thus, each of the records in the user interface 200 can be used by the controller 150 to create or represent a respective directed edge (having a weight represented by the contents of the field 242 multiplied by the contents of the field 244) between the nodes that are identified by the fields 240 and 246 in the product graph 152. The direction of the directed edge, represented by each record, flows from the predecessor component or process 246 to the component or process 240, representing the time order of the processes and components in the manufacturing process.

Multiple records may identify the same component or process identifier in the field 240. For example, the component identifier of “C2” is present in the field 240 in three different records: 202-8, 202-10, and 202-12, each of which has a different predecessor component/process identifier specified in the field 246. Thus, component “C2” has three different and alternative predecessor components 246 and is a part of at least three alternative manufacturing process paths. The associated waste credit rates 244 in the records may be the same, or some or all may be different. For example, lumber components can be connected via a variety of alternative components, such as glue, nails, or screws, and each may have a different waste credit rate 244. As a further example, the alternative processes of applying glue by hand versus driving nails via a nail gun versus drilling screws via a drill may have different waste credit rates 244.

As illustrated in FIG. 2, some records specify predecessor component/process identifiers 246 that indicate that the respective component or process does not exist, as in the example of records 202-2 and 202-4. The predecessor component or process does not exist because the corresponding component/process identifier 240 is the first component or process in the manufacturing process represented by the product graph 152. As illustrated in FIG. 2, some records specify component/process identifiers 240 that indicate that the respective component or process is the final product, as in the example of records 202-28, 202-30, 202-32, and 202-34. An indication that the component/process 240 is the final product means that the manufacturing process is complete when the manufacturing process reaches the component or process identified by that node.

FIG. 3 depicts a block diagram of an example product graph 152, according to an embodiment of the invention. The controller 150 reads the data from the records of FIG. 2, and uses the data to create the product graph 152. The product graph 152 describes various alternative manufacturing processes (by different combinations of processes and components) that start at a begin node 156-1 and result in producing a product, represented by the final node 156-10. The product graph 152 may be stored in the memory 102 as a linked list, an array, a database, a file, or any other appropriate data construct.

To define the product graph 152 more formally, a graph consists of two types of elements: a set of vertices (also called nodes) and a set of edges. Every edge has two endpoints in the set of nodes and is said to connect or join the two endpoints. The set of edges can thus be defined as a subset of the family of all two-element sets of nodes. Often, however, the set of nodes is considered as a set, and the graph has an incidence relation that maps each edge to the pair of nodes that are its endpoints. Edges may be endowed with direction, leading to the notion of a directed graph, also called a digraph.

An arc, or directed edge, is an ordered pair of end nodes. In such ordered pair, the first node is called a head, or initial node; and the second node, a tail, or terminal node. Thus, the direction of an edge designates which of the ordered pair is the head and which is the tail. In contrast, an undirected edge disregards any sense of direction and treats both end nodes interchangeably. A loop, also called a cycle, in a digraph, keeps a sense of direction, but treats both the head and tail nodes identically, meaning the head and tail of the directed edge are identical. A set of arcs are multiple, or parallel, if they share the same head and the same tail. A pair of arcs are anti-parallel if one's head/tail is the other's tail/head. A digraph, or directed graph, or oriented graph, is analogous to an undirected graph except that all of its edges are arcs. A mixed graph may contain both directed and undirected edges. A digraph is called simple if it has no loops and at most one arc between any pair of nodes.

In a digraph, the out degree is the number of edges leaving a node, and the in degree is the number of edges entering a node. In a digraph, the degree of a node is equal to the sum of its out and in degrees. An edge that enters a node is called an entering directed edge (the node is the tail of the entering directed edge) of that node. A directed edge that leaves a node is called a leaving edge (the node is the head of the leaving edge) of that node.

An out-neighborhood, or successor set, of a node is the set of tails of arcs going from or leaving the node. Likewise, an in-neighborhood, or predecessor set of a node is the set of heads of arcs going into or terminating in the node.

A source is a node with a 0 in-degree, having no entering directed edges, which is illustrated, in the example of FIG. 3, as the begin node 156-1. But, all other nodes in FIG. 3 have an in-degree greater than zero, so in the product graph 152, the set of tail nodes are a subset of the set of all nodes in the product graph 152. A sink is a node with a 0 out-degree, which is illustrated, in the example of FIG. 3, as the final node 156-10.

A node v dominates another node u if a directed edge exists from the node v to the node u. A node subset S is out-dominating if every node not in S is dominated by some node in S; and is in-dominating if every node in S is dominated by some node not in S. An orientation is an assignment of directions to the edges of an undirected or partially directed graph. A tournament is a digraph in which each pair of nodes is connected by exactly one arc. In other words, it is an oriented complete graph.

A walk is an alternating sequence of a subset of the nodes and edges of the graph, beginning with a first-node and ending with a last-node, in which each node in the walk is incident to the two edges that precede and follow it in the sequence, and the nodes that precede and follow an edge are the end-nodes of that edge. The walk is said to be closed if its first-node and last-node are the same or open if its first-node and last-node are different. An open walk is also called a path. In various embodiments, all of the edges in the walk may be different or distinct (in which case the walk is also known as a trail), or some of the edges in the walk may be the same. A walk may be formed from any type of the graph.

A directed path is an oriented simple path, such that all arcs go the same direction, meaning all internal nodes of the directed path have in- and out-degrees of 1. A node v is reachable from another node u if a directed path exists that starts from u and ends at v. Note that, in general, the condition that u is reachable from v does not imply that v is also reachable from u.

If node v is reachable from node u, then the node u is a predecessor of the node v and the node v is a successor of the node u. If there an arc exists from the node u to the node v, then the node u is a direct predecessor of the node v, and the node v is a direct successor of the node u.

A digraph is strongly connected if every node is reachable from every other following the directions of the arcs. On the contrary, a digraph is weakly connected if its underlying undirected graph is connected. A weakly connected graph can be thought of as a digraph in which every node is “reachable” from every other but not necessarily following the directions of the arcs. A strong orientation is an orientation that produces a strongly connected digraph.

A directed cycle is an oriented simple cycle such that all arcs go the same direction, meaning all nodes have in- and out-degrees 1. A digraph is acyclic if it does not contain any directed cycle. A finite, acyclic digraph with no isolated nodes necessarily contains at least one source and at least one sink.

Thus, the directed product graph 152 includes nodes 156-1, 156-2, 156-3, 156-4, 156-5, 156-6, 156-7, 156-8, 156-9, and 156-10. The nodes 156 (FIG. 1) generically refers to the nodes 156-1, 156-2, 156-3, 156-4, 156-5, 156-6, 156-7, 156-8, 156-9, and 156-10. The directed product graph 152 further includes directed edges 158-2, 158-4, 158-6, 158-8, 158-10, 158-12, 158-14, 158-16, 158-18, 158-20, 158-22, 158-24 158-26, 158-28, 158-30, 158-32, and 158-34, which the controller 150 created from the data in the respective records 202-2, 202-4, 202-6, 202-8, 202-10, 202-12, 202-14, 202-16, 202-18, 202-20, 202-22, 202-24 202-26, 202-28, 202-30, 202-32, and 202-34. The directed edges 158 (FIG. 1) generically refer to the directed edges 158-2, 158-4, 158-6, 158-8, 158-10, 158-12, 158-14, 158-16, 158-18, 158-20, 158-22, 158-24 158-26, 158-28, 158-30, 158-32, and 158-34.

Each of the directed edges 158-2, 158-4, 158-6, 158-8, 158-10, 158-12, 158-14, 158-16, 158-18, 158-20, 158-22, 158-24 158-26, 158-28, 158-30, 158-32, and 158-34 has a respective associated weight, which represents the waste credits consumption of the processor component represented by the tail or terminal node of the respective directed edge, which the controller 150 creates by multiplying the quantity 242 by the waste credit rate 244 from the corresponding record. For example, the directed edge 158-2 flows from the begin node 156-1 to the node 156-2 (“C1”) because record 202-2 specifies “none” as the predecessor component/process identifier 246 and “C1” as the component/process identifier 240. The directed edge 158-2 has an associated weight of “−1” because the quantity 242 of “1” multiplied by the waste credit rate 244 of “−1” from record 202-2 yields “−1.” As another example, the directed edge 158-4 flows from the begin node 156-1 to the node 156-3 (“P3”) because record 202-4 specifies “none” as the predecessor component/process identifier 246 and “P3” as the component/process identifier 240. The directed edge 158-4 has an associated weight of “4” because the quantity 242 of “1” multiplied by the waste credit rate 244 of “4” from the record 202-4 yields “4.”

The example product graph 152 of FIG. 3 includes many alternative paths that start at the begin node 156-1 and culminate at the final node 156-10. These alternative paths represent alternative manufacturing processes and have different lengths (different sums of their weights or waste credits associated with or stored in the directed edges of the paths). A first example directed path includes the node 156-1, followed by the directed edge 158-2, followed by the node 156-2, followed by the directed edge 158-10, followed by the node 156-5, followed by the directed edge 158-22, followed by the node 156-8, followed by the directed edge 158-30, and followed by the node 156-10, which has a length, total weight, or total waste credit of −1+2+−3+3=1. A second example directed path includes the node 156-1, followed by the directed edge 158-2, followed by the node 156-2, followed by the directed edge 158-6, followed by the node 156-4, followed by the directed edge 158-18, followed by the node 156-7, followed by the directed edge 158-28, and followed by the node 156-10, which has a length, total weight, or total waste credit of −1+3+5+2=9. But, many more example alternative directed paths exist in the product graph 152, some of which share no common nodes and no common edges, and some of which share some common nodes and/or some common edges.

FIG. 4 depicts a block diagram of an example shortest path 154, according to an embodiment of the invention. The shortest path 154 is a subset of the product graph 152 and represents a manufacturing process that begins at the begin node 156-1 and ends at the final node 156-10, representing the resulting product of the manufacturing process. The shortest path 154 is a weighted directed path and includes, in order, the node 156-1, followed by the directed edge 158-2, followed by the node 156-2, followed by the directed edge 158-10, followed by the node 156-5, followed by the directed edge 158-22, followed by the node 156-8, followed by the directed edge 158-30, and followed by the node 156-10, which has a length, total weight, or total waste credit of −1+2+−3+3=1.

The shortest path 154 is the shortest, or has the lowest total weight or lowest total waste credit of all directed paths that start at the node 156-1 and end at the node 156-10. The controller 150 determines the shortest path 154 by analyzing the product graph 152, as further described below with reference to FIG. 5. The controller 150 further stores the shortest path 154, e.g., in the memory 102 and displays or presents the shortest path 154 via the user terminal 121. The shortest path 154 represents the manufacturing process that consumes the least amount of waste credits, as compared to all other manufacturing processes that start at the node 156-1 and end at the product represented by the node 156-10.

FIG. 5 depicts a flowchart of example processing for finding a shortest path in a product graph 152, according to an embodiment of the invention. Control begins at block 500. Control then continues to block 505 where the controller 150 receives component identifiers, process identifiers, quantities, waste credit rates, and predecessor processes and component identifiers from the user interface 200 or from stored data, e.g., data stored in a file or database or from the network 130. Control then continues to block 510 where the controller 150 determines whether all waste credit rates have been received for all components and processes for all alternative manufacturing processes that result in a product.

If the determination at block 510 is true, then the controller 150 has received or read all waste credit rates for all components and processes, so control continues to block 515 where the controller 150 creates the directed product graph 152 and represents the received processes, components, and predecessor processes and predecessor components as nodes and directed edges in the directed product graph 152. Control then continues to block 520 where the controller 150 calculates the total waste credit consumption amounts for each tail node in the directed product graph 152 and stores the respective total waste credit consumption amount as respective weights of the respective entering directed edges of the respective tail nodes. The controller 150 performs the calculation by multiplying the received quantity 242 by the received waste credit rate 244.

Control then continues to block 525 where the controller 150 inverts the sign of the weight for each tail node that has a net receipt of waste if the sign was not already negative, which changes the sign to negative, indicating that the weight represents a net receipt of waste (receiving waste by the process or component from the environment and thus reducing the waste in the environment). Control then continues to block 530 where the controller 150 finds the shortest path 154, i.e., the path from the begin node to the final node of the product graph 152 that has the lowest total waste credit, that is, the path where the sum of the weights (the sum of the waste credits of each directed edge in the directed path) is lower than for the sum of the respective weights in all other paths from the begin node 156-1 to the end node 156-10.

In an embodiment, the controller 150 finds the shortest path 154 of the directed product graph 152 using an enhanced Bellman-Ford algorithm, as illustrated below using the Python computer language. The algorithm finds the shortest path 154 in the directed product graph 152 from the begin node 156-1 to the final node 156-10.

```
      #!/usr/bin/python
def bellman_ford(graph, source):
  d = { }
  p = { }
  for node in graph:
    d[node] = float(‘Inf’)
    p[node] = None
  d[source] = 0
  for i in range(len(graph)−1):
    for u in graph:
      for v in graph[u]:
        if d[v] > d[u] + graph[u][v]:
          d[v] = d[u] + graph[u][v]
          p[v] = u
  for u in graph:
    for v in graph[u]:
      assert d[v] <= d[u] + graph[u][v]
  return d, p
graph = {
    ‘begin’: {‘c1’: −1, ‘p3’: 4},
    ‘c1’: {‘p2’: 3, ‘c2’: 2, ‘c4’: 2},
    ‘p3’: {‘c2’: 2, ‘c4’: 4},
    ‘p2’: {‘c2’: 1, ‘c3’: 5},
    ‘c2’: {‘p1’: −3},
    ‘c4’: {‘p1’: −1, ‘end’: 2, ‘c5’: 1},
    ‘c3’: {‘end’: 2, ‘p1’: 2},
    ‘p1’: {‘end’: 3},
    ‘c5’: {‘end’: 2},
    ‘end’: { }
    }
d, p = bellman_ford(graph, ‘begin’)
print “D: ”, d
print “P: ”, p
```

In the above algorithm:

graph: represents the product graph 152;

d: represents the distance (the waste credits cost) of the shortest path 154;

p: represents the shortest path 154;

node: represents a node (vertex) in the product graph 152;

source: represents the begin node 156-1 of the product graph 152;

u: is a temporary variable that represents a node in the product graph 152;

v: is a temporary variable that represents a node in the product graph 152;

graph[u] [v]: is a function that returns the weight (the waste credit) of the directed edge from node u to node v in the product graph 152;

Inf: is a number that represents infinity or a number larger than the maximum possible weight (the waste credit) assigned to any directed edge in the product graph 152;

range(len(graph)−1): is a function or functions that return the number of nodes in the product graph 152; and

assert: is a Python function that raises an error message if the expression evaluates to false, and is used in the above algorithm to raise an error if a cycle with a negative weight occurs in the product graph 152, in which case a shortest path 154 does not exist.

The algorithm determines the shortest path 154 by relaxing all of the directed edges and performs this relaxing a number of times equal to the number of nodes in the product graph 152 minus one. These repetitions allow minimum distances to accurately propagate throughout the product graph 152, since, in the absence of negative cycles, the shortest path 154 can only visit each node at most once.

In another embodiment, the shortest path 154 may be found by the Floyd-Warshall algorithm, which compares all possible paths through the product graph 152 between each pair of nodes. The Floyd-Warshall algorithm incrementally improves an estimate on the shortest path 154 between two nodes, until the estimate is optimal. Consider a graph G with nodes V, each numbered 1 through N. Further, consider a function shortestPath(i, j, k), which returns the shortest possible path from node i to node j using only nodes 1 through k as intermediate points. The shortestPath function is defined in terms of the following recursive formula:

```
    shortestPath(i, j, k) = min(shortestPath(i, j, k−1), shortestPath(i,
k, k−1) + shortestPath(k, j, k−1)); and
    shortestPath(i, j, 0) = edgeWeight(i, j).
```

The Floyd-Warshall algorithm works by first computing shortestPath(i, j, 1) for all (i, j) pairs, then using that result to find shortestpath(i, j, 2) for all (i, j) pairs, and so on. This process continues until k=n, yielding the shortest path 154 for all (i, j) pairs using any number of intermediate nodes.

In other embodiments, any appropriate algorithm may be used for finding the shortest path 154.

Control then continues to block 535 where the controller 150 stores the found and determined shortest path 154, e.g., to the memory 102, and presents or displays the shortest path via the user terminal 121. Control then continues to block 540 where the product represented by the final node is produced using the manufacturing process represented by the shortest path 154. That is, the manufacturing process represented by the shortest path 154 is performed by executing the processes and acquiring the components represented by the nodes of the shortest path 154, which results in production of the product represented by the final node 156-10. Control then continues to block 599 where the logic of FIG. 5 returns. In another embodiment, the manufacturing process is redesigned to use different components, different processes, a different order (different predecessors), or different waste credits. The data input via the user interface 200 is then modified, and the logic of FIG. 5 is re-executed.

If the determination at block 510 is false, then the controller 150 has not received or read all waste credit rates for all components and processes, so control continues to block 545 where the controller 150 divides the processes and components for which waste credit rates have not been received into smaller units, presents the smaller units (sub-processes or sub-components) via the user terminal 121 and prompts the user to enter further quantities, waste credit rates, and predecessor nodes and processes. Control then returns to block 505, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
creating a directed graph comprising a plurality of nodes and a plurality of directed edges that connect the plurality of nodes, wherein the plurality of nodes represent components and processes, and wherein the plurality of directed edges represent a time order of the components and processes in a plurality of manufacturing processes;
calculating a plurality of amounts of waste credits for a plurality of respective tail nodes in the directed graph;
storing the plurality of amounts of waste credits as weights of entering directed edges of the respective tail nodes; and
finding a shortest path from a begin node of the directed graph to a final node of the directed graph.

2. The method of claim 1, wherein the finding further comprises:
finding the shortest path that has a lowest sum of the weights, as compared to all other paths from the begin node to the final node.

3. The method of claim 1, wherein the waste credits represent tradable permits for the components and processes to emit waste.

4. The method of claim 1, further comprising:
inverting a sign of the weights for the respective components and processes that receive waste.

5. The method of claim 1, further comprising:
receiving quantities of the components and the processes from a user interface;
receiving waste credit rates from a user interface; and
calculating the plurality of amounts of waste credits by multiplying the respective waste credit rates by the respective quantities.

6. The method of claim 1, further comprising:
performing one of the plurality of manufacturing processes represented by the shortest path.

7. The method of claim 1, further comprising:
displaying the shortest path.

8. A storage medium encoded with instructions, wherein the instructions when executed comprise:
creating a directed graph comprising a plurality of nodes and a plurality of directed edges that connect the plurality of nodes, wherein the plurality of nodes represent components and processes, and wherein the plurality of directed edges represent a time order of the components and processes in a plurality of manufacturing processes;
calculating a plurality of amounts of waste credits for a plurality of respective tail nodes in the directed graph;
storing the plurality of amounts of waste credits as weights of entering directed edges of the respective tail nodes; and
finding a shortest path from a begin node of the directed graph to a final node of the directed graph.

9. The storage medium of claim 8, wherein the finding further comprises:
finding the shortest path that has a lowest sum of the weights, as compared to all other paths from the begin node to the final node.

10. The storage medium of claim 8, wherein the waste credits represent tradable permits for the components and processes to emit waste.

11. The storage medium of claim 8, further comprising:
inverting a sign of the weights for the respective components and processes that receive waste.

12. The storage medium of claim 8, further comprising:
receiving quantities of the components and the processes from a user interface;
receiving waste credit rates from a user interface; and
calculating the plurality of amounts of waste credits by multiplying the respective waste credit rates by the respective quantities.

13. The storage medium of claim 8, further comprising:
performing one of the plurality of manufacturing processes represented by the shortest path.

14. The storage medium of claim 8, further comprising:
displaying the shortest path.

15. A computer system comprising:
a processor; and
memory connected to the processor, wherein the memory encodes instructions that when executed by the processor comprise:
creating a directed graph comprising a plurality of nodes and a plurality of directed edges that connect the plurality of nodes, wherein the plurality of nodes represent components and processes, and wherein the plurality of directed edges represent a time order of the components and processes in a plurality of manufacturing processes,
calculating a plurality of amounts of waste credits for a plurality of respective tail nodes in the directed graph,
storing the plurality of amounts of waste credits as weights of entering directed edges of the respective tail nodes, and
finding a shortest path from a begin node of the directed graph to a final node of the directed graph.

16. The computer system of claim 15, wherein the finding further comprises:
finding the shortest path that has a lowest sum of the weights, as compared to all other paths from the begin node to the final node.

17. The computer system of claim 15, wherein the waste credits represent tradable permits for the components and processes to emit waste.

18. The computer system of claim 15, wherein the instructions further comprise:
inverting a sign of the weights for the respective components and processes that receive waste.

19. The computer system of claim 15, wherein the instructions further comprise:
performing one of the plurality of manufacturing processes represented by the shortest path.

20. The computer system of claim 15, wherein the instructions further comprise:
displaying the shortest path.
